(19) United States
(12) Patent Application Publication
(10) Pub. No.: US 2020/0036256 A1
(43) Pub. Date: Jan. 30, 2020

(54) HOUSING HAVING HALF-SHELL DESIGN FOR ELECTRIC MACHINES, AND METHOD FOR MANUFACTURING SAID HOUSING

(71) Applicants: ThyssenKrupp Steel Europe AG, Duisburg (DE); thyssenkrupp AG, Essen (DE)

(72) Inventors: Lothar Patberg, Moers (DE); Fabian Schongen, Kempen (DE); Andreas Walter, Bochum (DE); Philipp Grunden, Duisburg (DE)

(73) Assignees: ThyssenKrupp Steel Europe AG, Duisburg (DE); thyssenkrupp AG, Essen (DE)

(21) Appl. No.: 16/484,235

(22) PCT Filed: Feb. 12, 2018
(86) PCT No.: PCT/EP2018/053405

§ 371 Date: Aug. 7, 2019

(30) Foreign Application Priority Data
Feb. 15, 2017 (DE) 10 2017 202 373.2

(51) Int. Cl. H02K 5/08; H02K 5/18; H02K 5/20; H02K 9/22; H02K 9/20; H02K 5/24; H02K 11/01; H02K 15/14

(52) U.S. Cl. CPC H02K 5/08; H02K 5/18; H02K 5/20; H02K 15/14; H02K 9/20; H02K 5/24; H02K 11/01; H02K 9/22

(57) ABSTRACT

The invention relates to a housing for an electric machine and a method for producing a housing for an electric machine from at least two shell portions which cover at least a portion of the periphery. At least one of the shell portions is produced from a metal sheet by means of at least one shaping operation and the metal sheet is at least partially provided with a plastics material layer prior to the shaping operation.

### TECHNICAL FIELD

In the field of electric machines, in particular electric motors, for example, for drives of vehicles or machine drives, metal housings are generally used. In this instance, cast housings of aluminum are conventional.

### BACKGROUND ART

WO 2007/051684 A1 discloses an electric motor which comprises two cup-like housings which are pushed one over the other, wherein a sleeve for forming cooling channels is inserted between the housings. In this instance, a high assembly complexity is necessary and the housing represents a high proportion of the weight of the electric motor.

### SUMMARY OF INVENTION

An object of the invention is consequently to provide a weight-reduced housing of an electric machine or electric motor which can be produced in an advantageous manner and which enables easy assembly.

Other objectives of the invention are an improvement of the electromagnetic shielding and a reduction of the so-called NVH properties (Noise, Vibration, Harshness), that is to say, the acoustic properties and the structure-borne noise vibrations.

This object is achieved with housings for electric machines, such as electric motors, generators and the like, according to the features of claim 8 produced according to a method according to the features of patent claim 1.

According to the invention a method for producing a housing for an electric machine from at least two shell portions which each cover at least a portion of the periphery is characterized in that at least one of the shell portions is produced from a metal sheet by means of at least one shaping operation, and in that the metal sheet, before, during or after the shaping operation is at least partially provided with a plastics material layer. The shell portions are in this instance produced in such a manner that they form at least a portion of the periphery of the motor housing and consequently cover with at least a portion of the stator of the electric motor. To this end, metal sheets, in particular steel sheets, are used and were provided at least at one side at least partially with a plastics material layer. In other embodiments of the invention, the metal sheets, in particular steel sheets, may be instead of partially coated also completely coated with a plastics material layer. The coated sheets are subsequently shaped into the form of the shell portions, in particular by means of deep-drawing, pressing, punching and/or bending operations, wherein they comprise at least a portion of the peripheral face of the subsequent motor housing and preferably at least a portion of at least one end face of the motor housing.

In preferred embodiments, the shell portions cover uniform regions of the periphery, in particular in each case 120° or 180°, wherein symmetries can be used and the component number and variant number, that is to say, number of different components, can be kept small.

In alternative preferred embodiments, an at least partial covering of a peripheral region of more than 180° is preferred as long as the remaining clear width of the opening corresponds to the diameter of the stator or the stator can be inserted via a purely resilient deformation of the shell portion. The assembly and positioning of the stator can thereby be simplified.

Other embodiments of the method are characterized in that before, during or after the shaping operation, functional elements are applied to the plastics material layer. The functional elements are also produced from plastics material, preferably from the same or similar plastics material as the plastics material layer, in particular a thermoplastic, preferably a polyamide, such as, for example, PA, PA6, PA66, PA610, or alternatively PES, PEI, PPSU and PPS and fiber-reinforced plastics materials, whereby the connection to the plastics material layer is simplified, and the required temperature resistance is produced. The application may, for example, be carried out by means of injection-molding, lamination, compression molding, laying tapes or prefabricated molded components, which are adhesively bonded or welded. For functional elements which are in regions of the metal sheet which are not intended to be shaped or which are intended to be only slightly shaped, such as, for example, stops, locking elements or auxiliary positioning means, the application is preferably carried out prior to the shaping, in particular when they are provided at the inner side since the production is thereby simplified. For functional elements, such as, for example, reinforcements, bearing or support elements whose shape is produced only after the shaping operation or which serve to reinforce the shell portion are applied after the shaping operation.

Other advantageous methods are characterized in that the functional elements are applied in one piece in a method step together with the plastics material layer before, during or after the shaping operation. As a result of simultaneous application, the required production steps are reduced and a secure connection of the functional elements is ensured.

Preferred embodiments of the method are characterized in that the functional elements contain a temperature control unit. The temperature control unit may be constructed as a cooling channel, thermal conducting elements, such as particles, heat pipe or the like, or a cooling rib. In order to ensure adequate cooling of the electric machine, the shell portions of the motor housing are, for example, provided with cooling channels as functional elements. The cooling channels may be fitted to the inner side and/or outer side of the shell portions on or together with the plastics material layer.

In embodiments of the invention, the method is characterized in that on the shell portions flange-like connection regions for connecting the shell portions to each other are produced by shaping and/or application to the metal sheet. In order to connect the individual shell portions to form a housing, the connection between the shell portions is preferably produced by means of a flange connection via which the portions are connected to each other, particularly screwed to each other. In preferred embodiments, during the connection at least one of the faces of the shell portions which come into contact with each other comprises the plastics material layer or is formed from plastics material. In other words, the flange region is shaped in such a manner that the plastics material layer is located within the flange connection which is intended to be formed or the flange represents a functional element which is applied to the metal sheet. As a result of the arrangement of plastics material in the flange connection, the metal components of the shell portions are separated from each other, whereby with regard to mechanical vibrations a better decoupling or damping takes place and consequently the acoustic properties are improved.

In other embodiments, the method is characterized in that at least partially an additional metal component is applied to the side of the plastics material layer. The additional metal component may in this instance be provided for local reinforcement, for temperature control or shielding or may also, for example, be provided as a short-circuit ring of the electric machine.

Other embodiments of the method are characterized in that the metal sheet is formed by a plurality of metal layers which are electrically insulated with respect to each other. The losses, for example, as a result of eddy currents, are thereby reduced and an electromagnetic shielding and the mechanical/acoustic damping are improved.

All embodiments have in common the fact that the metal sheet preferably comprises steel, in particular a low-permeability steel material (in accordance with standard SEW 390), preferably an austenitic high-Mn steel, X-IP steel and CrNi steel.

The above-mentioned embodiments relating to the method according to the invention can also be used in a similar manner for the housing according the invention produced therewith for electric machines.

Housings according to the invention for an electric machine which comprises at least one shell portion produced with a method described above are characterized in that the shell portion comprise connection regions and comprise a metal sheet, and in that the metal sheet at least partially comprises a plastics material layer. In this instance, all the shell portions may be produced using a method according to the invention or also shell portions according to the invention with housing portions which are produced differently or corresponding machine or installation components can be connected to form a motor housing according to the invention.

Embodiments of the housing are characterized in that the shell portions comprises functional elements which are provided on the plastics material layer. These functional elements may be bearing locations, stops, auxiliary positioning means, temperature control units (for example, cooling channels) and the like.

In other embodiments, motor housings according to the invention are characterized in that the plastics material layer and the functional elements are constructed in one piece.

Other embodiments of the housing are characterized in that the connection regions are constructed as flanges, in which the plastics material layer and/or functional elements of the respective shell portions are connected to each other. The contact between the shell portions consequently takes place via at least one plastics material layer or via functional elements which are constructed as plastics flanges.

Embodiments of the housing are characterized in that the functional elements comprise at least one temperature control unit.

Other embodiments of the housing are characterized in that at least partially an additional metal component is provided on the side of the plastics material layer.

Motor housings may also be characterized in other embodiments in that the metal sheet is formed from a plurality of metal layers which are electrically insulated with respect to each other.

As a result of embodiments of sheet steel, in particular austenitic steel with low permeability, a good electromagnetic shielding is produced and, as a result of the additional metal components and/or the structure comprising a plurality of metal layers which are electrically insulated with respect to each other, can be improved. With a correspondingly good shielding, components of the electronic power system can be fitted to the outer side of the housing, which in the prior art with high power densities is currently often not possible.

### BRIEF DESCRIPTION OF DRAWINGS

The invention will be explained in greater detail below with reference to schematic drawings, wherein identical components are provided with the same reference numerals. In detail in the drawings:

FIG. 1 is a partially sectioned perspective view of an embodiment of an electric motor according to the invention, and

FIG. 2 is a detailed view at the periphery of a shell portion in the region of an end of the stator.

### BEST MODE FOR CARRYING OUT THE INVENTION

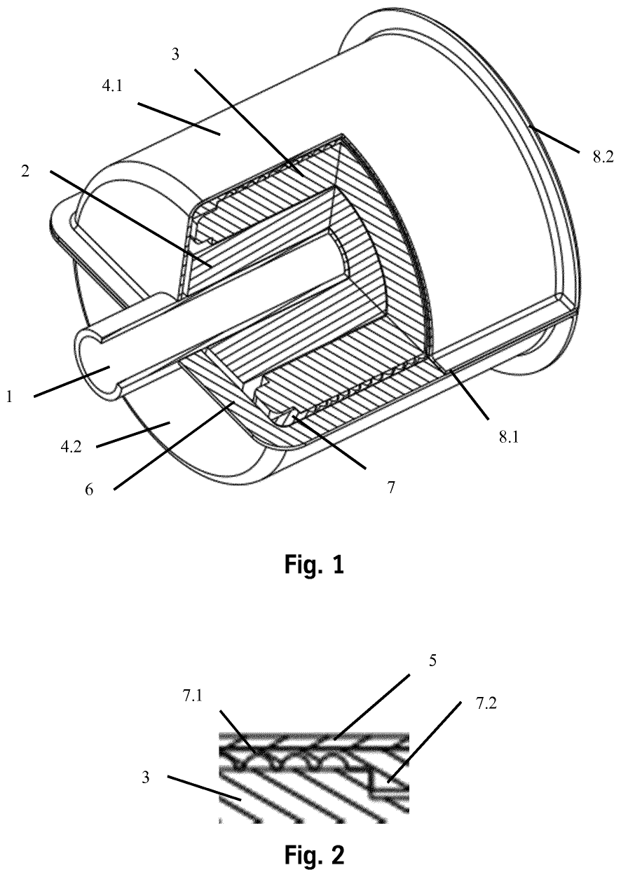

FIG. 1 shows an electric motor in a schematically illustrated embodiment according to the invention. An electric motor comprises a motor shaft (1) which is connected to the rotor (2), wherein the rotor (2) is surrounded by the stator (3). The motor housing in the example illustrated is composed of three components, wherein two shell portions (4.1, 4.2) according to the invention are combined with a bearing shield which terminates an end side of the motor. The shell portions (4.1, 4.2) are in this embodiment constructed in an identical and symmetrical manner and surround in each case a peripheral angle of 180° of the electric motor and together form a pot-like housing. The two shell portions (4.1, 4.2) are connected to each other by means of a flange-like connection region (8.1). Via the flange (8.2) the bearing shield which is not illustrated in this view is connected to the shell portions (4.1, 4.2).

The shell portions (4.1, 4.2) are in this embodiment provided with a plastics material layer (6) over the entire surface. In the flange-like connection region (8.1), the two shell portions (4.1, 4.2) are brought into contact with each other via this plastics material layer (6). Functional elements (7) are provided on the inner peripheral surface of the shell portions (4.1, 4.2).

FIG. 2 is an enlarged detailed illustration of the outer peripheral region of an electric motor according to the invention in the region of an end of the stator (3). The shell portion comprises a metal sheet (5). In this embodiment, the plastics material layer and the functional elements are constructed in one piece. The stator is surrounded by cooling channels (7.1) as a functional element and its positioning is facilitated by a stop (7.2) as an additional functional element.

The different features of the invention can be freely combined with each other and are not limited only to the examples of embodiments described or illustrated. Thus, the plastics material layer and the functional elements may also be provided contrary to the exemplary illustration on the outer side of the shell portion or on both sides.

### LIST OF REFERENCE NUMERALS

1 Motor shaft

2 Rotor

3 Stator

4.1, 4.2 Shell portion

5 Metal sheet

6 Plastics material layer

7 Functional element

7.1 Cooling channel

7.2 Stop

8.1 Flange-like connection region

8.2 Flange

1. A method for producing a motor housing for an electric machine from at least two shell portions which each cover at least a portion of the periphery, wherein at least one of the shell portions is produced from a metal sheet by means of at least one shaping operation, and in that the metal sheet is at least partially provided with a plastics material layer prior to the shaping operation.

2. The method as claimed in claim 1, wherein before, during or after the shaping operation functional elements are applied to the plastics material layer.

3. The method as claimed in claim 2, wherein the functional elements are applied in one piece in a method step together with the plastics material layer before the shaping operation.

4. The method as claimed in claim 3, wherein the functional elements are provided with a temperature control unit.

5. The method of claim 4 wherein on the shell portions flange-like connection regions for connecting the shell portions to each other are produced by one of shaping and application to the metal sheet.

6. The method of claim 5 wherein an additional metal component is applied to the side of the plastics material layer.

7. The method of claim 6 wherein the metal sheet is formed by a plurality of metal layers which are electrically insulated with respect to each other.

8. A housing for an electric machine, which comprises at least one shell portion produced with a method as claimed in claim 7 wherein the shell portion comprise flange-like connection regions and comprise a metal sheet and in that the metal sheet at least partially comprises a plastics material layer.

9. The housing as claimed in claim 8, wherein the shell portions comprises functional elements which are provided on the plastics material layer.

10. The housing as claimed in claim 9, wherein the plastics material layer and the functional elements are constructed in one piece.

11. The housing as claimed in claim 10, wherein the flange-like connection regions are constructed as flanges, in which at least one of the plastics material layer and functional elements of the respective shell portions are connected to each other.

12. The housing as claimed in one of claim 11, wherein the functional elements comprise at least one temperature control unit.

13. The housing as claimed in claim 12, wherein an additional metal component is provided on the side of the plastics material layer.

14. The housing as claimed in claim 13, wherein the metal sheet is formed from a plurality of metal layers which are electrically insulated with respect to each other.
